(19) United States
(12) Patent Application Publication
(10) Pub. No.: US 2013/0329428 A1
(43) Pub. Date: Dec. 12, 2013

(54) LIGHT EMITTING DIODE (LED) ASSEMBLY

(71) Applicants: Mario LEMAY, St-Bruno (CA); Charles-Antoine POIRIER, Montreal (CA)

(72) Inventors: Mario LEMAY, St-Bruno (CA); Charles-Antoine POIRIER, Montreal (CA)

(21) Appl. No.: 13/493,452

(22) Filed: Jun. 11, 2012

(51) Int. Cl. F21V 7/00; F21V 29/00

(52) U.S. Cl. 362/247; 362/249.02

(57) ABSTRACT

The present relates to an Light Emitting Diode (LED) assembly. The LED assembly comprises at least one LED mounted on an LED board, a heat sink, a driver assembly, and a height adjustment sleeve. The heat sink dissipates heat generated by the at least one LED. The driver assembly electrically and mechanically connects the LED assembly in a light source. The height adjustment sleeve adjusts a luminous centre of the LED assembly, the height adjustment sleeve being positioned between the driver assembly and the heat sink. The LED assembly also comprises at least one reflector, for directing a light generated by the at least one LED mounted on the LED board.

### TECHNICAL FIELD

The present relates to the field of Light Emitting Diodes (LED), and more particularly to a LED assembly.

### BACKGROUND

Light sources rely on a light-emitting material. Traditionally, the light-emitting material that was used for incandescent light sources was a tungsten filament. In the past decade, light sources based on light emitting diodes (LEDs) have been introduced. LEDs are semiconductors which upon movement of electrons therein, release energy in the form of light. LEDs are suitable for various lighting applications. Moreover, LEDs share interesting properties: low operating temperature, small volume, possible to use multiple LEDs in a single light source; fast response; and relatively long lifetime.

Because LEDs are semiconductors, they require sub-components which were not required for incandescent lights. Such sub-components typically include: an LED board for mounting the LED, a heat sink to dissipate the heat generated by the LED, a reflector to direct the light generated by the LED, and a driver assembly to integrate the LED assembly to the light source.

Light sources vary significantly in terms of design, shape, and size. These variations in shapes and sizes make it difficult to design an LED assembly suitable for many types of light sources. There is therefore a need for an LED assembly to facilitate retrofitting of legacy light bulbs to more energy efficient LED assemblies.

### SUMMARY

The present disclosure relates to an Light Emitting Diode (LED) assembly. The LED assembly comprises at least one LED mounted on an LED board, a heat sink, a driver assembly, and a height adjustment sleeve. The heat sink dissipates heat generated by the at least one LED. The driver assembly converts AC current into DC current to electrically feed the LED. The height adjustment sleeve adjusts a luminous centre of the LED assembly, the height adjustment sleeve houses the driver assembly and is positioned between the internal body of the fixture and the heat sink.

In accordance with another aspect of the present disclosure, the LED assembly comprises at least one reflector, for directing a light generated by the at least one LED mounted on the LED board.

### BRIEF DESCRIPTION OF THE DRAWINGS

In the appended drawings:

FIG. 1 illustrates an LED assembly; according to a non-restrictive illustrative embodiment;

FIG. 2 illustrates an LED board, according to a non-restrictive illustrative embodiment;

FIG. 3 illustrates a heat sink; according to a non-restrictive illustrative embodiment;

FIG. 4 illustrates a driver assembly installed in the adjustment sleeve; according to a non-restrictive illustrative embodiment;

FIG. 5 illustrates a height adjustment sleeve; according to a non-restrictive illustrative embodiment;

FIG. 6 illustrates an LED assembly integrated to a light source, according to a non-restrictive illustrative embodiment.

### DETAILED DESCRIPTION

The present disclosure relates to the field of Light Emitting Diodes (LED), and more particularly to an LED assembly. An LED assembly is a component of an LED based light source. The LED assembly generates light and optimizes illumination produced by the LED(s) integrated in the LED assembly. The LED assembly also dissipates heat generated by operation of the LED(s).

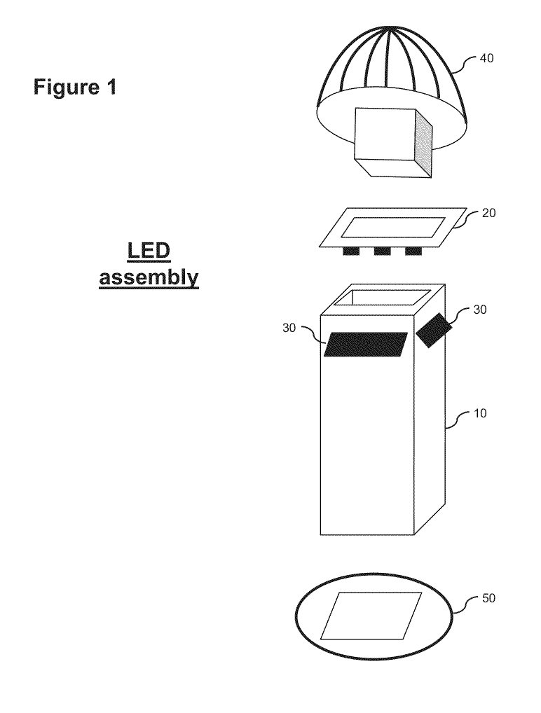

The LED assembly is represented in FIG. 1. The LED assembly comprises an LED board 20, a heat sink 40, driver assembly 50, and a height adjustment sleeve 10. The LED assembly may also comprise at least one reflector 30 (two reflectors 30 are represented in FIG. 1).

The LED assembly is integrated to a light source (not represented in FIG. 1). The light source corresponds to one among a variety of lighting applications, including indoor lighting devices (e.g. indoor lamps), and outdoor lighting devices (e.g. street lamps). Light sources vary significantly in terms of design, shape, and size. The LED assembly is designed to be suitable for many lighting applications, by adapting mechanically and electrically to various light sources. In particular, the LED assembly facilitates retrofitting of legacy light bulbs to more energy efficient LED assemblies.

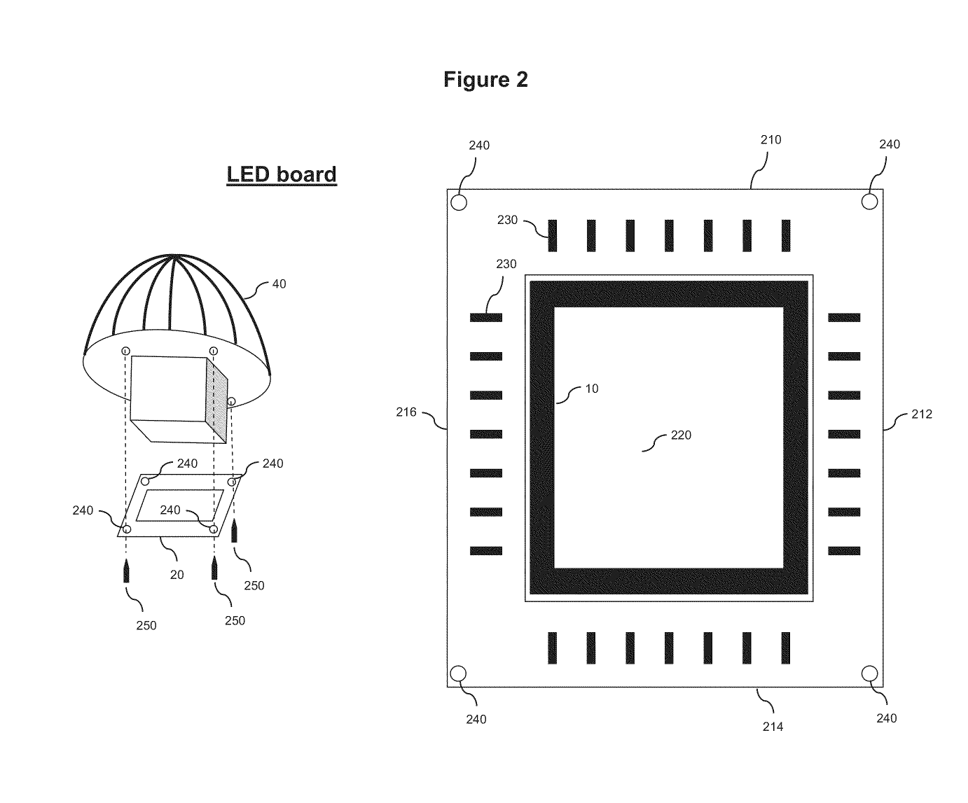

The LED board 20 generates the light of the light source. For this purpose, at least one LED is mounted on the LED board. An LED is a semiconductor, which upon movement of electrons therein, releases energy in the form of light. The LED board 20 will be further described later in the description, in relation to FIG. 2.

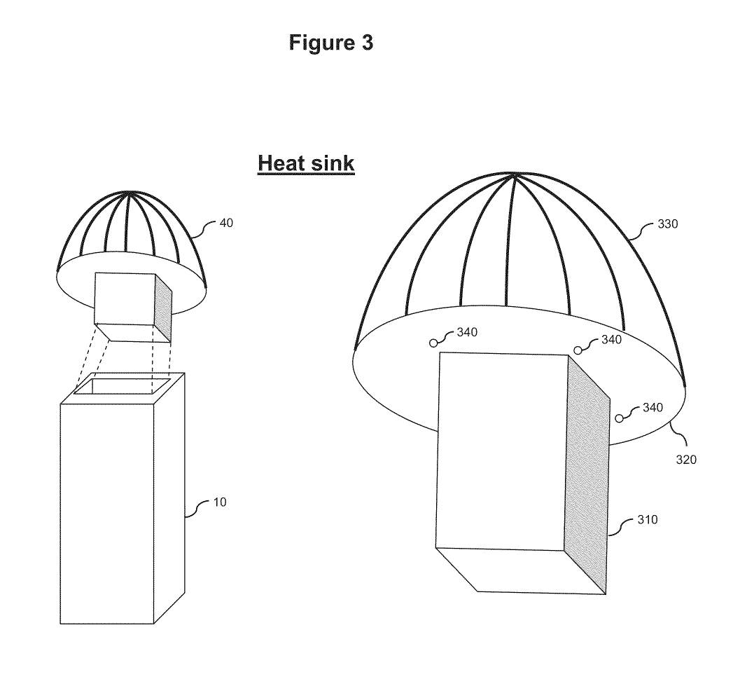

The heat sink 40 dissipates heat generated by the at least one LED on the LED board 20. Since LEDs are very sensible to heat, dissipating the heat generated by the LED(s) on the LED board 20 provides an optimal operating mode for the LEDs. Furthermore, dissipating the heat ensures a longer lifetime for the LEDs. The heat sink 40 will be further described later in the description, in relation to FIG. 3.

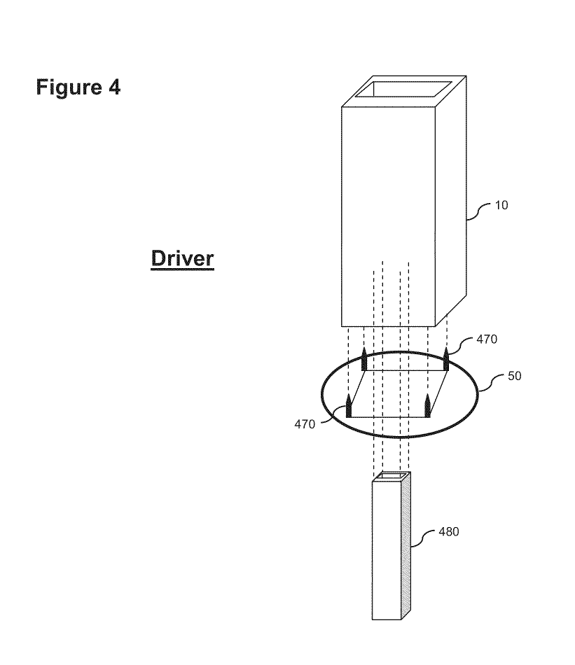

The driver assembly 50 provides DC electricity to the LED board The driver assembly 50 will be further described later in the description, in relation to FIG. 4.

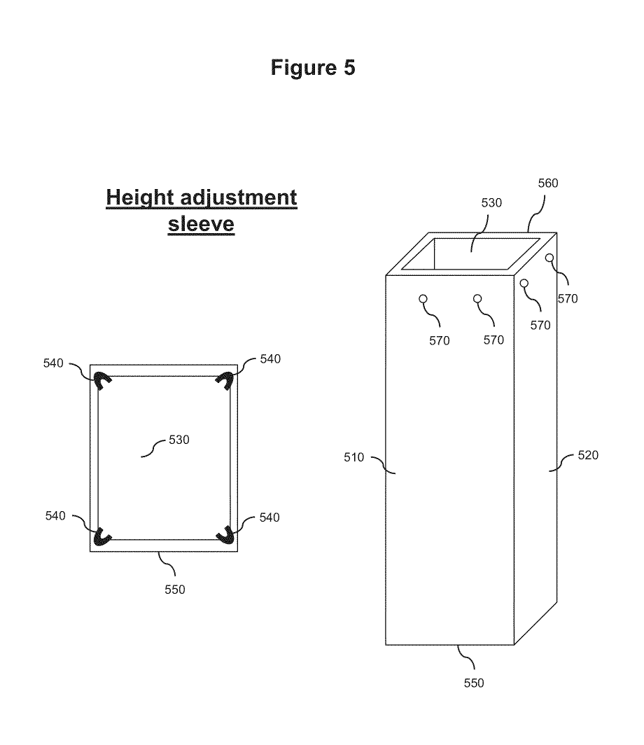

The height adjustment sleeve 10 allows for an adjustment of a luminous center of the LED assembly, with respect to the specific type of light source it is to be attached to. For instance, the size and shape of the height adjustment sleeve 10 may be adjusted, to several specific types of light sources. The height adjustment sleeve 10 is positioned between an installation disk of the driver assembly 50 and the heat sink 40. The height adjustment sleeve 10 will be further described later in the description, in relation to FIG. 5.

A reflector 30 directs light generated by the LED board 20. There may be one or several reflectors 30 attached to the LED assembly, based on each specific type of light source. The reflector 30 directs the light generated by the LED board 20, by the shape, position and reflective properties of the materials that compose the reflector 30. The reflectors 30 may have various designs, their design being adapted to optimize the light generated by the LED board 20. The reflectors 30 represented in FIG. 1 are attached to the height adjustment sleeve 10, representing one possible embodiment of the LED assembly design. The reflector(s) 30 will be further described later in the description, in relation to FIG. 5.

Referring now to FIGS. 1 and 2 concurrently, the LED board will be described. In the specific embodiment represented in FIG. 2, the LED board 20 has a rectangular shape, with a rectangular opening 220 in the middle, and four illuminating sides 210, 212, 214, and 216. On each of these illuminating sides, a series of LEDs 230 are disposed, according to a predefined pattern (number of LEDs on each illuminating side, position of the LEDs on each illuminating side, etc).

The LED board 20 also includes four screw ports 240, to attach the LED board 20 to the heat sink 40, by means of four screws 250. The upper surface of the LED board 20 is in contact with the heat sink 40. Thus, the heat generated by the LEDs on the LED board 20 is transmitted to the heat sink 40, to be further dissipated.

The LED board 20 represented in FIG. 2 has a rectangular shape, so that it fits with the parallelepiped shape of the height adjustment sleeve 10 represented in FIG. 1. The dimensions of the rectangular opening 220 are adapted to fit with the external dimensions of the height adjustment sleeve 10. As represented in FIG. 2, the LED board 20 is wrapped around the height adjustment sleeve 10, while being attached to the heat sink 40. Since the opening 220 is rectangular, it is adapted to the parallelepiped shape of the height adjustment sleeve 10.

Although shown as a rectangular parallelepiped, the present LED board 20 may embody various alternative shapes and designs, to accommodate different types of light distributions. For instance, instead of four illuminating sides 210, 212, 214, and 216; only three illuminating sides may be included on the LED board 20 (e.g. side 210 is not present).

Referring now to FIGS. 1 and 3 concurrently, the heat sink will be described. An issue with the LED technology is the dissipation of the heat generated by an LED during its operations. LEDs are more sensitive to their operating temperature than traditional (e.g. incandescent) light-emitting materials. Moreover, since multiple LEDs may be used in a single light source (on the LED board 20), the capability to efficiently dissipate the generated heat is potentially critical. The failure to properly dissipate the heat generated by the LEDs may result in reducing the efficiency of the LED(s) (reducing the light output). It may also result in damaging the LEDs, and/or reducing their lifetime.

The heat sink 40 of FIG. 1 is represented in FIG. 3 with three sub-components 310, 320, and 330.

Sub-component 310 adjusts mechanically the heat sink 40 to the height adjustment sleeve 10, and makes them fit together. Since the height adjustment sleeve 10 represented in FIG. 1 has a parallelepiped shape, the sub-component 310 also has a parallelepiped shape, however the shape of the sub-component 310 may be adapted to fit any shape of opening in the height sleeve. Sub-component 310 is easily inserted inside the parallelepiped opening in the height adjustment sleeve 10 and maintained in a stable position at the top of the height adjustment sleeve 10. Additionally, screws may be used to maintain the heat sink mechanically inserted at a specific position within the height adjustment sleeve 10.

Sub-component 320 provides a surface of contact between the heat sink 40, and the LED board 20. For this purpose, the LED board 20 may be attached to the sub-component 320 by means of several screws (as represented in FIG. 2). Screw ports 340 may be included in the sub-component 320, to attach the LED board 20 to the heat sink 40, by means of the screws. The heat generated by the LEDs on the LED board 20 is transmitted to the sub-component 320, via the aforementioned surface of contact.

Sub-component 330 dissipates the heat generated by the LEDs on the LED board 20. The shape of the sub-component 330 may be optimized to offer the largest possible surface for a given volume, in order to increase heat dissipation. The heat is transmitted from the LEDs on the LED board 20 to the sub-component 320 (the surface of contact), and from there to the sub-component 330 (the heat dissipation shape).

Referring now to FIGS. 1 and 4 concurrently, the driver assembly will be described. The driver assembly 50 connects mechanically and electrically the LED assembly with the light source (not represented in FIG. 4). The driver assembly 50 provides a mechanical connection to attach the LED assembly to the light source. The driver assembly 50 also provides an electrical connection with an electrical source of power embedded in the light source. This electrical connection is used to power the LEDs on the led board 20 of FIG. 1.

The driver assembly 50 may vary in size and design. It is represented in FIG. 4, as a cylindrical board with a rectangular opening in its center. This rectangular opening in the center of the driver assembly 50 is adapted to fit in shape and size with shape and size of the height adjustment sleeve 10. Also, the size of the rectangular opening in the driver assembly 50 and the size of the parallelepiped opening inside the height adjustment sleeve 10 of the presently depicted LED assembly are the same, for mechanical adjustment purposes. Additionally, four screws 470 are represented in FIG. 4. The four screws 470 may be used to maintain the driver assembly 50 attached to the height adjustment sleeve 10. For example, there may be one screw per corner of the height adjustment sleeve 10.

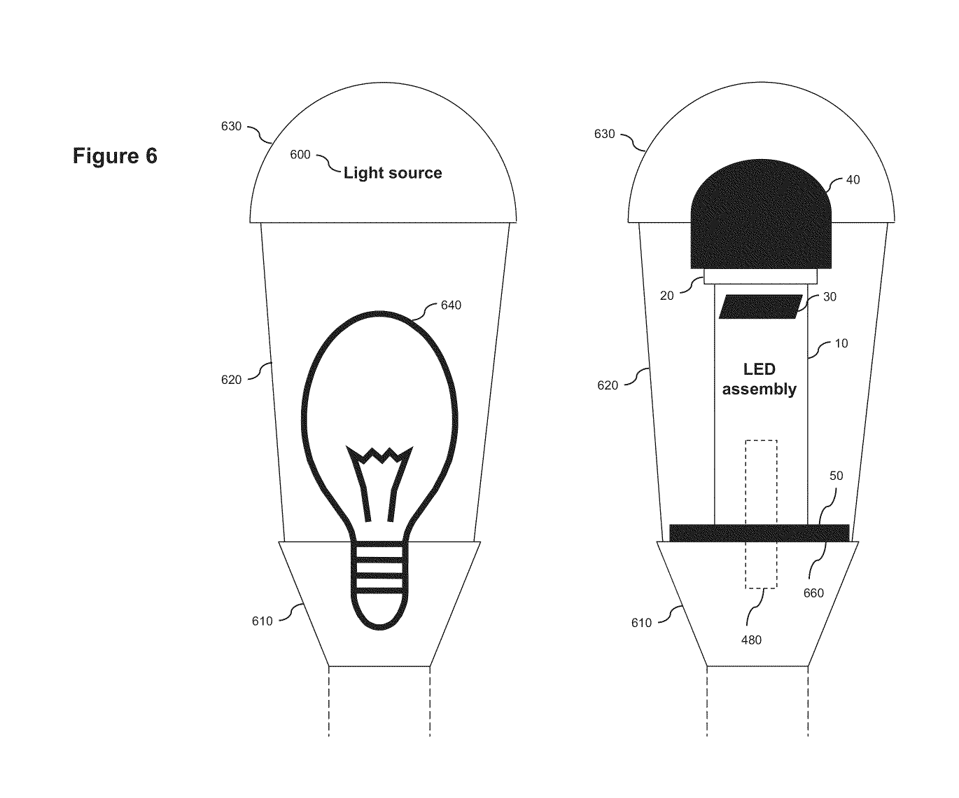

The driver assembly 50 is further attached to the light source (not represented in FIG. 4) by any appropriate mechanism. For instance, the driver assembly 50 may be in contact with a cylindrical surface of the light source, and attached to this cylindrical surface by an appropriate number of screws. The connection between the driver assembly 50 and the exemplary cylindrical surface of the light source implements the mechanical connection between the LED assembly and the light source. FIG. 6 will further illustrate this exemplary mechanical connection.

An electrical power device 480 is also represented in FIG. 4. It is an entity of the light source, which provides electrical power to the LED assembly. The electrical power device 480 may for example be inserted inside the LED assembly (as represented in FIG. 4), through the opening in the driver assembly 50, and further in the opening in the height adjustment sleeve 10. The electrical power device 480 represented in FIG. 4 has a parallelepiped form (for illustration purposes only). The opening in the driver assembly 50 and the opening in the height adjustment sleeve 10 are adapted to the section of the electrical power device 480, to enable electrical connection with and possibly partial insertion of the electrical power device 480 inside the height adjustment sleeve 10, through the driver assembly 50. The electrical power device 480 may further be connected to the LED board 20 of FIG. 1 via an appropriate number of electrical wires (not represented in FIG. 4). The insertion of the electrical power device 480 through the opening in the driver assembly 50 may implement the electrical connection between the LED assembly and the light source.

Referring now to FIGS. 1 and 5 concurrently, the height adjustment sleeve will be described. The role of the height adjustment sleeve 10 is to adjust the luminous centre of the LED assembly. The luminous center of the LED assembly is defined by the respective positions of the LED board 20 and reflectors 30 (represented in FIG. 1). By adjusting the height of the adjustment sleeve 10, the position of the luminous center of the LED assembly may be adapted to various types of light sources.

The height adjustment sleeve 10 is positioned between the driver assembly 50 and the heat sink 40 (as represented in FIGS. 4 and 3 respectively). In one exemplary embodiment, the reflectors 30 are attached to the height adjustment sleeve 10 (as represented in FIG. 1), however the present LED assembly is not limited to having reflectors 30 attached thereto. The LED board 20 is not attached to the height adjustment sleeve 10, but to the heat sink 40 (as represented in FIG. 2).

In one example as shown on FIG. 5, the height adjustment sleeve 10 has a parallelepiped shape, with four vertical surfaces. Each vertical surface may have a rectangular shape. Two vertical surfaces 510 and 520 of the height adjustment sleeve 10 are represented in FIG. 5. The thickness of the vertical surfaces may be limited to the thickness necessary to ensure that the height adjustment sleeve 10 is stable and rigid.

The opening 530 at the top 560 of the height adjustment sleeve 10 may allow for the insertion of the heat sink 40 in the height adjustment sleeve 10, as represented in FIG. 3. Additional screw ports (not represented in FIG. 5) may be included in the vertical surfaces of the height adjustment sleeve 10, to maintain the heat sink 40 inserted at a certain position within the height adjustment sleeve 10.

The bottom 550 of the height adjustment sleeve 10 may include four screw ports 540 on each corner, to attach the driver assembly 50 to the height adjustment sleeve 10 (as represented in FIG. 4). The opening 530 at the bottom 550 of the height adjustment sleeve 10 may allow for the insertion of an electrical power device 480 in the height adjustment sleeve 10, as represented in FIG. 4.

One or several reflector(s) 30 may be attached to or form part of the height adjustment sleeve 10. Each reflector 30 may be located on one of the vertical surfaces of the height adjustment sleeve 10, for instance vertical surface 510 or 520. The reflectors 30 may be positioned near the top 560 of the height adjustment sleeve 10, in order to be close to the LEDs on the LED board 20, to direct the light generated by these LEDs.

The LED assembly includes at least one illuminating side, and the LED assembly comprises one reflector 30 per illuminating side. In the case of the height adjustment sleeve 10 represented in FIG. 5, each vertical surface (e.g. 510 and 520) represents a potential illuminating side. Referring now also to FIG. 2 which represents a particular embodiment, the LED board 20 may include LEDs on one of its four illuminating sides (210, 212, 214, or 216), and the corresponding vertical surface (e.g. 510 and 520) on the height adjustment sleeve 10 may comprise one reflector.

In a specific embodiment of the present, the LED assembly includes four illuminating sides. For this purpose (referring now also to FIG. 2), the LED board 20 includes LEDs on its four illuminating sides (210, 212, 214, and 216). In this case, the LED assembly comprises four reflectors 30, one per vertical surface (e.g. 510 or 520) of the height adjustment sleeve 10.

In another specific embodiment of the present, the LED assembly includes three illuminating sides. For instance (referring now also to FIG. 2), the LED board 20 includes LEDs on three of its four illuminating sides (e.g. 210, 212, 214), and no LEDs on the remaining side (216). The side without LEDs (216) may be removed from the design of the LED board 20. In this case, the LED assembly comprises three reflectors 30, on three of the four vertical surfaces (e.g. 510 or 520) of the height adjustment sleeve 10, corresponding to the sides of the LED board 20 on which LEDs are present.

For example, in the case of an outdoor street light, it may be necessary to generate light in every direction. In this case, the LED assembly with four illuminating sides is used. But in certain conditions, it may be necessary to generate light in three directions only (for instance, when the street needs illumination, but not the houses on the border of the street). In that case, the LED assembly with three illuminating sides (to light the street) may be used.

In an alternative embodiment, reflectors 30 may not be used as standalone entities of the LED assembly. Instead, reflectors may be directly incorporated to the height adjustment sleeve 10. For this purpose, the portion of the height adjustment sleeve 10 which comprises the reflecting material may have appropriate shape and reflecting properties, to adequately direct the light generated by the LEDs on the LED board 20.

In still another alternative embodiment, the LED board 20 may be positioned inside the height adjustment sleeve 10. Thus, the reflectors 30 may be mechanically connected inside the height adjustment sleeve 10, to direct the light generated by the LEDs on the LED board 20. In this particular embodiment, openings are present in the height adjustment sleeve 10, to allow the light generated by the LEDs on the LED board 20 to reach the outside, and generate a proper illumination.

In the particular example represented in FIG. 5, the height adjustment sleeve 10 has a parallelepiped shape to provide specific advantages: stability, rigidity, simple implementation and construction, and easily cut in different lengths in order to accommodate various types of light sources (which may vary in size and design). The height adjustment sleeve 10 may be designed in any other shape, which provides some or all of the aforementioned advantages. Additionally, the specific design of the height adjustment sleeve 10 may allow the usage of the LED assembly as a retrofit kit, from a legacy light source towards an LED based light source.

The height adjustment sleeve 10 may also participate in the heat dissipation, via its surfaces which are in contact with the heat sink 40. For this purpose, the height adjustment sleeve 10 may be made of a material capable of conducting and dissipating heat.

In one specific embodiment of the present, the height adjustment sleeve 10 is extruded.

Referring now to FIG. 6, an LED assembly integrated to a light source will be described. In the left part of FIG. 6, a light source 600 is represented. For simplification purposes, only the components of the light source 600 illustrating the integration of the LED assembly with the light source 600 have been represented.

The light source 600 includes a support 610, a glass envelop 620, and a protective cover 630. For illustration purposes, a traditional incandescent bulb 640 is mechanically and electrically connected to the light source 600, via the support 610.

In the right part of FIG. 6, the integration of the LED assembly with the light source 600 is illustrated. All the constituents of the LED assembly introduced in FIG. 1 are represented in FIG. 6: the LED board 20, the heat sink 40, the driver assembly 50, the height adjustment sleeve 10, and one reflector 30.

The integration of the LED assembly with the light source 600 is achieved via the driver assembly 50. The driver assembly 50 provides an electrical and mechanical connection of the LED assembly with the light source 600.

The mechanical connection is implemented by attaching the driver assembly 50 to a surface of contact 660, on top of the support 610 of the light source 600. As already mentioned previously in the description, some screws (not represented in FIG. 6) may be used to attach the driver assembly 50 to the support 610, via the surface of contact 660.

FIG. 6 illustrates that integrating the LED assembly to a specific light source 600 is easily accomplished. The shape and length of the height adjustment sleeve 10 are set to fit with the shapes and dimensions of specific components of the light source (for instance, the support 610, the glass envelop 620, and the protective cover 630 in the case illustrated in FIG. 6). Thus, the LED assembly may be inserted in various types of light sources 600, by adapting the shape and length of its height adjustment sleeve 10.

Although the present LED assembly has been described in the foregoing description by way of illustrative embodiments thereof, these embodiments can be modified at will, within the scope of the appended claims without departing from the spirit and nature of the appended claims.

1. An Light Emitting Diode (LED) assembly comprising:
at least one LED mounted on an LED board;
a heat sink for dissipating heat generated by the at least one LED;
a driver assembly for electrically and mechanically connecting the LED assembly in a light source; and
a height adjustment sleeve for adjusting a luminous centre of the LED assembly, the height adjustment sleeve being positioned between the driver assembly and the heat sink.

2. The LED assembly of claim 1, wherein the LED assembly comprises at least one reflector for directing a light generated by the at least one LED mounted on the LED board;

3. The LED assembly of claim 2, wherein the LED assembly includes at least one illuminating side, and the LED assembly comprises one reflector per illuminating side.

4. The LED assembly of claim 3, wherein the LED assembly includes three illuminating sides, and the LED assembly comprises three reflectors.

5. The LED assembly of claim 3, wherein the LED assembly includes four illuminating sides, and the LED assembly comprises four reflectors.

6. The LED assembly of claim 2, wherein the at least one reflector is mechanically connected outside the height adjustment sleeve.

7. The LED assembly of claim 2, wherein the at least one reflector is part of the height adjustment sleeve.

8. The LED assembly of claim 2, wherein the at least one reflector is mechanically connected inside the height adjustment sleeve.

9. The LED assembly of claim 1, wherein the height adjustment sleeve is extruded.

9. The LED assembly of claim 1, wherein the height adjustment sleeve is adjustable in at least one of size and shape.

11. The LED assembly of claim 1, wherein the height adjustment sleeve has a parallelepiped shape.

12. The LED assembly of claim 1, wherein the LED board is mechanically connected to the heat sink.
